(19) United States
(12) Patent Application Publication
(10) Pub. No.: US 2023/0419966 A1
(43) Pub. Date: Dec. 28, 2023

(54) VOICE TRANSCRIPTION FEEDBACK FOR VIRTUAL MEETINGS

(71) Applicant: Zoom Video Communications, Inc., San Jose, CA (US)

(72) Inventor: Brandon Kevin Roper, Washington, UT (US)

(21) Appl. No.: 17/849,306

(22) Filed: Jun. 24, 2022

(51) Int. Cl. G10L 15/26; G06F 40/232; H04L 12/18

(52) U.S. Cl. CPC G10L 15/26; H04L 12/1831; G06F 40/232

(57) ABSTRACT

Systems and methods for providing voice transcription feedback for virtual meetings are provided herein. In an example, a system may include a non-transitory computer-readable medium, a communications interface, and a processor. The processor may execute instructions to establish a virtual meeting having a plurality of participants, each participant of the plurality of participants exchanging one or more audio streams via the virtual meeting and to generate a transcript of at least a subset of the one or more audio streams exchanged during the virtual meeting using a speech recognition system. The processor may also execute instructions to transmit, to a first client device, one or more segments of the transcript, and receive, from the first client device, a correction to one or more transcribed words within the one or more segments of the transcript. The processor may also execute instructions to update the speech recognition system based on the correction to the one or more transcribed words within the transcript.

### FIELD

The present application generally relates to videoconferences and more particularly relates to systems and methods for providing voice transcription feedback for virtual meeting.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1, 2, and 3 show example systems for providing voice transcription feedback for virtual meeting, according to an embodiment herein;

FIG. 4 shows a graphical user interface during a virtual meeting being transcribed, according to an embodiment herein;

FIG. 5 illustrates an example speech recognition system that may be locally or remotely executed, according to an embodiment herein;

FIG. 6 illustrates an example transcription feedback system that may be locally or remotely executed, according to an embodiment herein;

FIG. 7 illustrates an example transcription feedback prompt, according to an embodiment herein;

FIG. 8 illustrates a review prompt for transcription feedback, according to an embodiment herein;

FIG. 9 illustrates a metric prompt for transcription feedback, according to an embodiment herein;

FIG. 10 illustrates an exemplary method for providing voice transcription feedback for virtual meeting, according to an embodiment herein; and

FIG. 11 shows an example computing device suitable for providing voice transcription feedback for virtual meeting, according to this disclosure.

### DETAILED DESCRIPTION

Examples are described herein in the context of systems and methods for providing voice transcription feedback for virtual meeting. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Video conference providers can enable people to interact with each other using their own computers (or “client devices”) with both video and audio in a variety of settings, such as in one-on-one conversations, group meetings, and webinars. While each of these types of settings can allow people to interact with each other, they can differ in character. For example, one-on-one conversations include only two people and may involve only a small amount of data being transmitted between the two client devices. Group meetings may involve a larger number of people all interacting with each other. In contrast, webinars typically involve a group of people that are attending to hear presentations from one or more presenters. Thus, in a webinar, interaction tends to be mostly one-way: from the presenter(s) to the audience. In addition, webinars can have very large numbers of participants, potentially numbering in the thousands or tens of thousands.

As the popularity of virtual meetings to replace conventional, in-person meetings, continues to rise, so too does the reliance on transcription systems, especially for those with hearing impairments. Transcription systems often perform speech recognition on audio exchanged during virtual meetings to provide voice-to-text functionality. Presently, however, there is little-to-no feedback on the accuracy of a transcription. That is, the transcription system may transcribe a word wrong and never be adjusted to correctly transcribe the word in the future. Thus, the inaccurate transcription of the word may perpetuate across numerous transcriptions unless the transcription system is adjusted.

Inaccuracies within a transcription can be frustrating and even impact a participant's experience in a virtual meeting, especially for hearing-impaired participants. For example, inaccuracies in a speech recognition and transcription process may cause a transcription to not make sense, thereby causing confusion to participants relying on the transcript for context during and/or after the virtual meeting. Accordingly, there is a need for feedback on the accuracy of a transcription process and/or the resulting transcript.

To provide feedback on the accuracy of a transcript, systems and methods for providing voice transcription feedback are provided herein. The systems and methods for providing voice transcription feedback can allow virtual meeting participants to provide feedback on the accuracy of one or more transcribed words corresponding to audio streams exchanged during the meeting. For example, after a virtual meeting terminates, a participant may receive a prompt requesting feedback on one or more transcribed words. The speech recognition system may identify the one or more transcribed words based on a low confidence score and request feedback from meeting participants on the accuracy of the transcription. The voice transcription feedback functionality provided herein allows participants to review and provide feedback on the accuracy of the one or more transcribed words. For example, a participant may indicate that the one or more transcribed words were accurately transcribed and the speech recognition system may use this feedback to increase the confidence score of the transcribed words. In another example, the participant may indicate that the one or more transcribed words were inaccurately transcribed and, in some cases, provide a correction for the one or more transcribed words. The speech recognition system may use this feedback to correct the transcription of the one or more transcribed words (e.g., to update the record of the meeting for future attending and searching capabilities). The correction to the one or more transcribed words may be used to update the speech recognition system such to improve the accuracy of the one or more transcribed words in another voice-to-text processes.

To encourage transcription feedback from participants, the transcription feedback functionality may also provide a feedback metric to a participant. The feedback metric may indicate how many corrections have been made based on the participant's feedback on an inaccurate transcription of a word. For example, a participant may receive a prompt indicating that the participant's feedback on a particular word has resulted in the word being correctly transcribed 100 times. In other examples, the prompt may indicate the number of correct transcriptions that have been made based on all the feedback received from the participant.

This illustrative example is given to introduce the reader to the general subject matter discussed herein and the disclosure is not limited to this example. The following sections describe various additional non-limiting examples and examples of systems and methods for providing voice transcription feedback for virtual meeting.

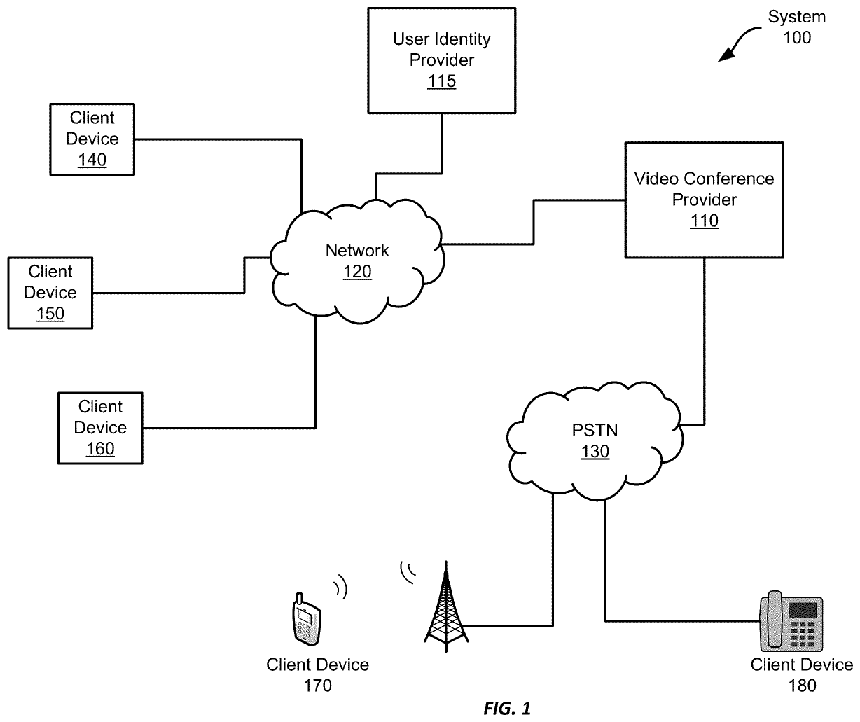

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the video conference provider 110 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

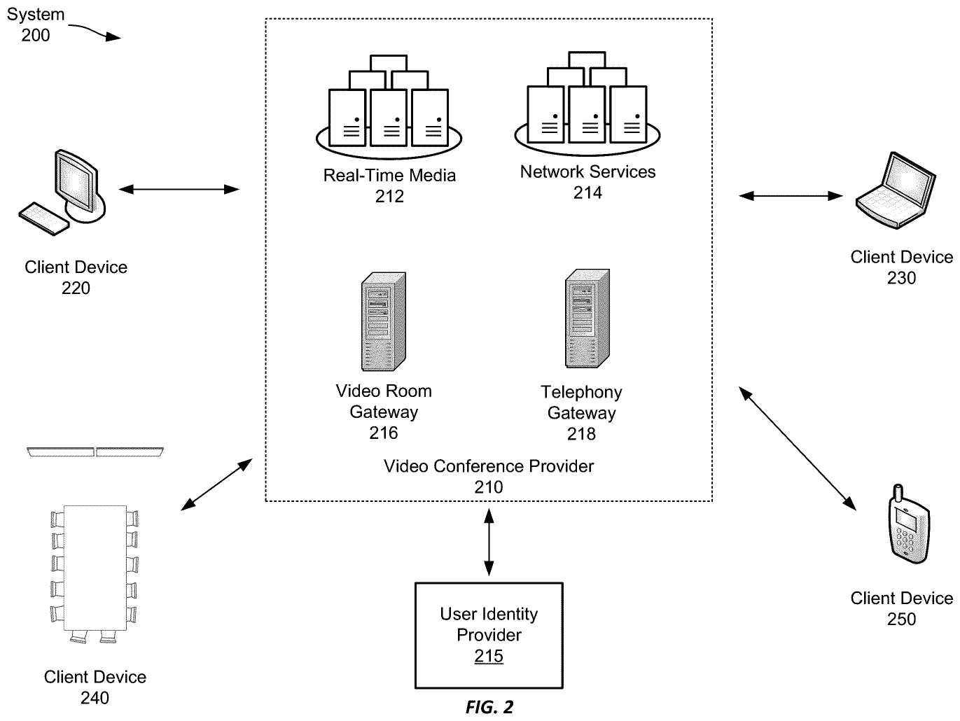

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can making conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different Examples of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

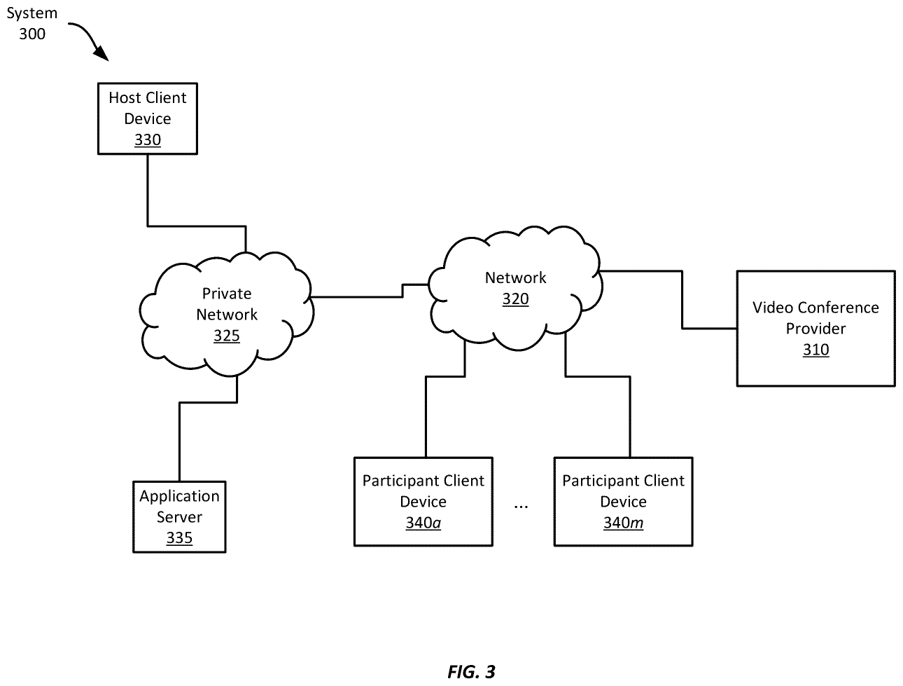

Referring now to FIG. 3, FIG. 3 shows an example system 300 for providing voice transcription feedback for a virtual meeting. In this example, a video conference provider 310 provides video conference services to multiple different client devices 330 and 340a-m, generally as described above with respect to FIGS. 1 and 2. In this example, the client devices 330 and 340a-m participate in a meeting hosted by the video conference provider 310. Client devices 340a-m connect to the video conference provider 310 over a public network 320, e.g., the internet; however, host client device 330 participates from within a private network 325, such as from their office at work. In addition to the host client device 330, an application server 335 is connected to the private network and makes various business applications available to the host client device 330. In different examples, these business applications may vary; however, in this example, the application server 335 provides applications to access business databases and files. To access these various resources, the host client device 330 has different client applications installed on it and may also have web applications accessible via a web browser, which may be stored as bookmarks in the web browser.

To start a meeting, the host client device 330 connects to the video conference provider 310 and begins a virtual meeting (“meeting”) at the video conference provider 310, such as by beginning a scheduled meeting, generally as described above with respect to FIGS. 1 and 2. The video conference provider 310 may create and manage the meeting as discussed above.

Once the virtual meeting is started, participants may be able to interact with other participants and see their respective names, such as in close proximity to other participants' video streams or in a list of participants visible in a graphical user interface (“GUI”). In some embodiments, the participants may only be able to see information, e.g., names or video feeds, from the host(s) of the meeting or certain select participants that will be engaged in discussions during the virtual meeting, such as panelists in a panel discussion. Still other limits may be imposed on the various participants, such as their ability to react to occurrences during the meeting, e.g., participants may be allowed to interact with their GUI to raise their hand to ask a question, but may not be allowed to provide any other feedback.

During or after the meeting, one of the participant client devices 340a-m or the host client device 330 may request a transcription of one or more audio streams exchanged during the meeting. For example, the participant client device 340a may request live transcription during the virtual meeting. In such an example, the participant device 340a may receive a transcript during the virtual meeting of any spoken words exchanged via the audio streams. In another example, the participant client device 340a may record the meeting and after the meeting is terminated, the participant client device 340a may request a transcript of the meeting recording. Those skilled in the art may readily appreciate that a participant may request a transcript of a virtual meeting in a variety of scenarios and situations.

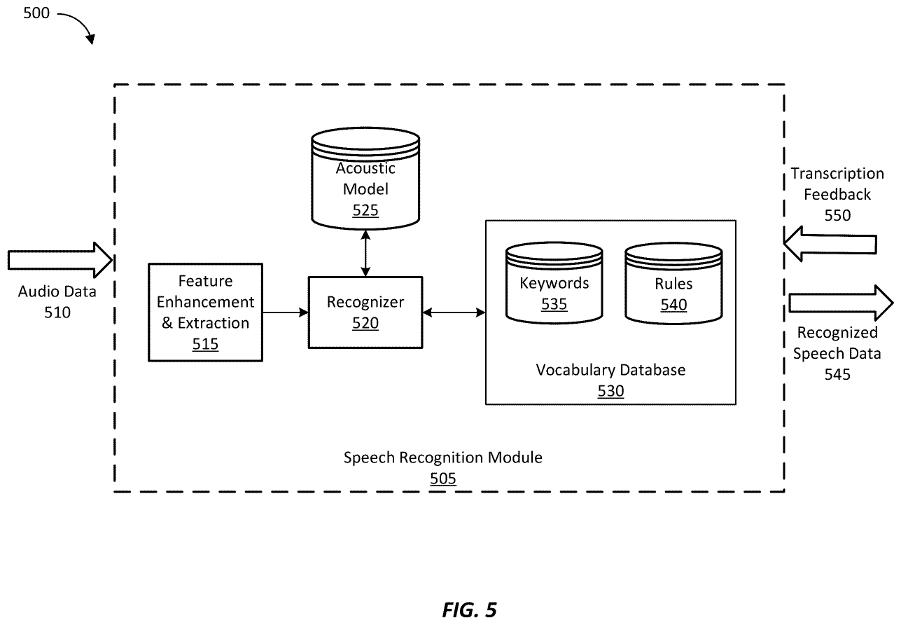

Upon request of the transcript, the video conference provider 310 may receive the transcription request and begin transcribing one or more audio streams associated with the virtual meeting. For example, if the participant client device 340a request a transcript of the audio streams from the virtual meeting, the video conference provider 310 may receive the request and begin transmitting a transcript of the audio streams to the participant client device 340a. As will be discussed in greater detail below with respect to FIG. 5, the video conference provider 310 may initiate a speech recognition process upon receipt of the transcription request. In some embodiments, the speech recognition process may be performed by a speech recognition system. The speech recognition system may be locally or remotely executed. In some cases, the speech recognition system may be hosted by a third party. In such embodiments, the video conference provider 310 may transmit the audio stream data to the third party for speech recognition and/or transcription. The video conference provider 310 may receive the speech recognition data and/or transcript from the third party and transmit the transcript to the participant client device 340a.

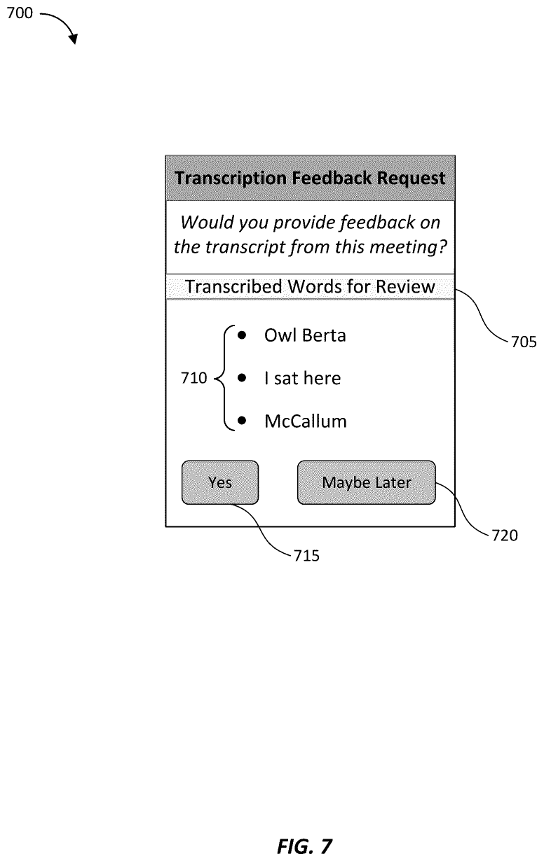

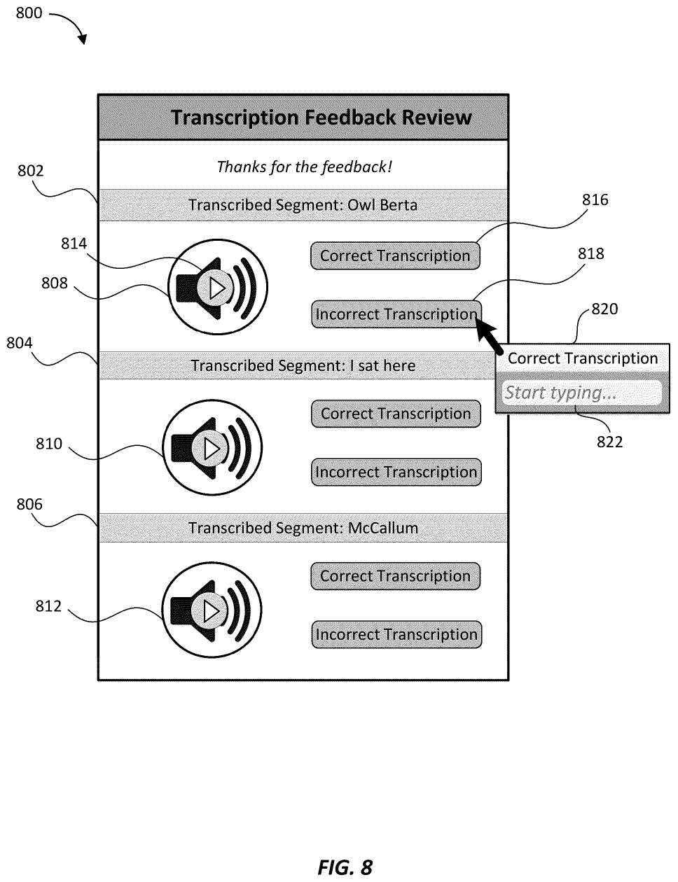

After the virtual meeting terminates, the video conference provider 310 may transmit to one or more of the participant client devices 340a-m and/or host client device 330, a request for feedback on the transcript. For example, the video conference provider 310 may transmit a transcribed word or words to the participant client device 340a and request feedback as to the accuracy of the transcribed word or words. In some embodiments, the video conference provider 310 may transmit a snippet of the audio stream corresponding to the transcribed word or words to the participant client device 340a to provide context for the transcribed word. The transcription feedback and review processes are described in greater detail below with respect to FIGS. 7 and 8.

The participant client device 340a may provide feedback on the transcribed word or words to the video conference provider 310. For example, upon review, the participant client device 340a may determine that the transcribed word is incorrect and the participant client device 340a may provide a corrected transcribed word as feedback. The participant client device 340a may transmit the feedback on the transcribed word to the video conference provider 310.

The video conference provider 310 may receive the feedback on the transcribed word from the participant client device 340a and determine whether to incorporate the feedback into the speech recognition system. For example, the video conference provider 310 may elicit feedback from more than one of the participant client devices 340a-m and compare the feedback from each of the participant client devices 340a-m. The video conference provider 310 may analyze the responses and determine a most accurate correction for the transcribed word or words. For example, the video conference provider 310 may determine a most common correction received from the participant client device 340a-m. In some embodiments, the video conference provider 310 may analyze a profile associated with the participant client devices 340a-m providing the feedback to determine a confidence level in the participant's feedback. If the participant client device 340a consistently provides feedback and/or the participant client device 340a's feedback is typically consistent with other participants' feedback, than the video conference provider 310 may determine a high confidence level for the participant client device 340a's feedback. In contrast, if the participant client device 340b rarely provides feedback and/or the participant client device 340b's feedback is often inconsistent when compared to other participant's feedback, then the video conference provider 310 may determine a low confidence level in the participant client device 340b's feedback.

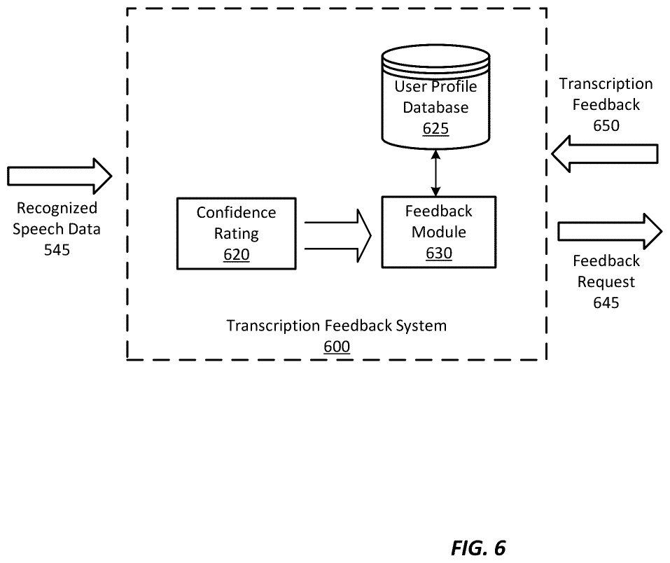

Upon determination that a transcribed word or words is inaccurate and that the received feedback is the correct transcription, the video conference provider 310 may update the speech recognition system to correctly transcribe the word and/or the original transcript. As will be discussed in greater detail below with respect to FIGS. 5 and 6, the video conference provider 310 may update a vocabulary database within the speech recognition system to provide for a correct transcription of a word. The correction may be disseminated through one or more speech recognition systems associated with the video conference provider 310 to improve the voice-to-text functionality of virtual meetings hosted by the video conference provider 310.

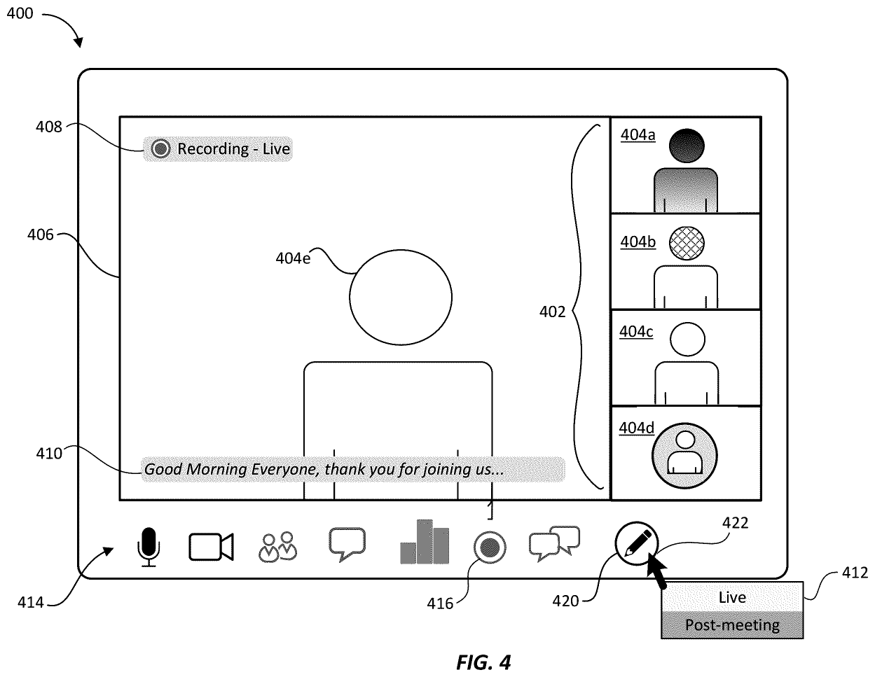

Referring now to FIG. 4, a graphical user interface (GUI) 400 during a virtual meeting is provided, according to an embodiment herein. The GUI 400 may be presented to a participant or a host during a virtual meeting. The following figures and related components, such as GUI 400 of FIG. 4, will be described with respect to the system shown in FIG. 3, however, any suitable system according to this disclosure may be employed, such as those described in FIGS. 1 and 2.

In some embodiments, a GUI 400 is viewable to a participant of the video conference on the participant's device, for example the GUI 400 may be viewable to participant A on the client device 340a. Presentation of the GUI 400 on the participant's device may be in response to the initiation of the virtual meeting.

The GUI 400 may include a roster 402 of the participants 404a-e in the virtual meeting. The roster 402 may include a video stream of some or all of the participants 404a-e. In other embodiments, the roster 402 may include a picture, image, representation, avatar or a listing of some or all of the participants 404a-e who have joined the virtual meeting. For example, as illustrated, the participant 404a may use a representation, the participant 404b may user an avatar, the participant 404c may user his or her video stream, and the participant 404d may use a picture on the roster 402. When a participant joins the video conference, the joining participant is added to the roster 402.

Once the virtual meeting is initiated, video and audio streams may be exchanged between the participants 404a-e. Display 406 may display the video stream of a currently speaking participant 404e. The audio stream from participant 404e may also be transmitted along with the video stream. In some embodiments, more than one participant may be speaking, and in such cases, the display 406 may include two or more windows providing the video streams from the speaking participants.

The GUI 400 may also include a dashboard 414 containing one or more action selections. For example, the dashboard 414 may include a recording selection 416 that allows a participant to record the streams of audio and video during the video conference. To initiate recording of the virtual meeting, a participant may select the recording selection 416. The recording selection 416 may transmit a recording request to the video conference provider 310, which may transmit a notification or request to the other meeting participants, as noted above. If the recording request is accepted, then the meeting may be recorded. Upon recording, an indication 408 may be provided to indicate to the participants 404a-e that they are being recorded. The indication 408 may be helpful for the participants 404a-e to know that their audio and video streams are being recorded.

The dashboard 414 may also include a voice-to-text or transcription selection 420. The transcription selection 420 may, upon selection, provide a transcription of one or more audio streams being exchanged during the virtual meeting. A participant may use his or her cursor 422 to select the transcription selection 420. In some embodiments, a prompt 412 may be provided when the cursor 422 selects the transcription selection 420. The prompt 412 may provide various options associated with the transcription selection 420. In the illustrated example, the prompt 412 may provide an option to provide live transcription of the audio streams or to provide a transcript of the audio streams post-meeting.

If the participant selects the live transcription option in the prompt 412, then a live transcription 410 may be provided on the display 406. The live transcription 410 may provide a near instantaneous transcript of the audio streams as they are exchanged during the virtual meeting. That is, as the participant 404e speaks, a transcript of his or her spoken words may be provided on the display 406 via the live transcription 410.

If the participant selects the post-meeting transcription option in the prompt 412, then the participant may receive a transcript after the meeting terminates. In some cases, the transcript may be based on the recording of the virtual meeting. In scenarios where the meeting is not recorded by selection of the recording selection 416, then the audio streams from the virtual meeting may be recorded upon selection of the post-meeting transcription option within the prompt 412. In other words, if the meeting is not being recorded but a participant requests a transcript of the meeting, such as to review after the meeting, then the video conference provider 310 may record only the audio streams during the virtual meeting. In such a scenario, the selection of the post-meeting option may be treated the same or similar to the recording selection 416 since the audio streams are being recorded (e.g., participants may be notified that the audio streams are being recorded for transcription purposes).

Upon selection of the transcription selection 420, the audio streams exchanged during the virtual meeting may be transmitted to the video conference provider 310 to be processed by a speech recognition system and/or a transcription system. Referring now to FIG. 5, an example speech recognition system 500 that may be locally or remotely executed is provided, according to an embodiment herein. The following figures and related components, such as the speech recognition system 500 of FIG. 5, will be described with respect to the system shown in FIGS. 3 and 4, however, any suitable system according to this disclosure may be employed, such as those described in FIGS. 1 and 2.

The speech recognition system 500 may be executed locally or remotely. For example, the speech recognition system 500 may be locally executed on a client device, such as the client device 340a, however, in other embodiments, the speech recognition system 500 may be cloud-based and/or remotely executed by a video conference provider, such as the video conference provider 310, or a third party system.

The speech recognition system 500, along with the transcription feedback system 600 described in greater detail with respect to FIG. 6, may be used to perform one or more of the voice transcription feedback functions described herein, specifically, the speech recognition system 500 may be used to perform speech recognition on audio streams exchanged during the virtual meeting for transcription purposes. For example, in some embodiments, the speech recognition system 500 may be used to generate recognized speech data 545 from the audio streams exchanged during the virtual meeting. The speech data 545 may be used to generate the transcript of the audio streams and thus is understood to include transcribed words corresponding to spoken words from the audio streams.

To perform speech recognition, the speech recognition system 500 may include a speech recognition module 505. The speech recognition module 505 may receive audio data 510. The audio data 510 may correspond to audio captured by the client device 340a, for example by a microphone. In other embodiments, the audio data 510 may be received from the video conference provider 310. The audio data 510 may be a recording of an audio track or may be a transcript of the audio track. The speech recognition module 505 may be or include a speech recognition system or model as known in the art. The following is an example speech recognition module following an example speech recognition process, however, it should be understood that other speech recognition modules or processes may be used.

Once the audio data 510 is received by the speech recognition module 505, the audio data 510 may be processed by a feature enhancement and extraction module 515. The feature enhancement and extraction module 515 may analyze the audio data for features corresponding to words and then enhance and extract any identified features. The identified features may correspond to audio waveforms present in human speech.

The speech recognition module 505 may also include a recognizer 520. The recognizer 520 may receive the identified features from the audio data 510. The recognizer 520 may employ an acoustic model 525 and a vocabulary database 530 to determine or associate the identified features in the audio data 510 to one or more words.

In an example embodiment, the acoustic model 525 may analyze the raw audio waveforms in the identified features and determine a corresponding phoneme for each waveform. In some embodiments, this is performed at the character or subword level. The vocabulary database 530 may be a language model. The vocabulary database 530 may include a rules database 540 and a word database 535. The rules database 540 may provide various rules for speech, allowing the recognizer to discard any association of identified features (e.g., audio waveforms) to phonemes that are improbable given the constraints of proper grammar and the topic of discussion. Once an appropriate mapping of the identified features to phonemes is generated, the recognizer 520 may determine words associated with the phonemes. The words may be based on the words database 535.

In some embodiments, the speech recognition system 500 may mistranslate a word. For example, the recognizer 520 may misassociate a word with phonemes. Misassociation or misidentification of words based on phonemes may occur for various reasons, such as the speech recognition system 500 has never encountered the word before, thus the words database 535 does not include that particular word. Other scenarios that may be prone to misidentification, and thus prone to inaccurate transcription, include those in which the speaker has an accent or is speaking in another language.

Once the phonemes are associated with respective words, recognized speech data 545 is generated. It should be understood that this process may be performed nearly instantaneously. For example, the speech recognition module 505 may generate the recognized speech data 545 during the meeting as the audio streams are being received by the video conference provider 310 or another system that is hosting the speech recognition system 500. The recognized speech 545 may be then used to generate a transcript of the corresponding audio stream.

In some embodiments, the recognized speech data 545 may be transmitted to a transcription feedback system. Turning now to FIG. 6, a transcription feedback system 600 is provided, according to an embodiment herein. The transcription feedback system 600 may receive the recognized speech data 545 from the speech recognition system 500. In other embodiments, the transcription feedback system 600 may receive the transcript or a portion of the transcript generated from the recognized speech data 545.

In an example embodiment, the recognized speech data 545 may be continuously transmitted from the speech recognition system 500 to the transcription feedback system 600 as the recognized speech data 545 is generated. In other embodiments, the recognized speech data 545 may only be transmitted to the transcription feedback system 600 once the meeting is terminated and the transcription feedback process is initiated. For example, the transcription feedback process may only be initiated upon termination of a virtual meeting, while in another example, the transcription feedback process may be initiated at any time during the virtual meeting. The initiation of the transcription feedback process may vary depending on the settings for the virtual meeting. That is, an administrator and/or the host of a virtual meeting may set various settings for the transcription feedback process, including when to initiate the process. The administrator and/or the host may even disable the transcription feedback process, depending on a desired level of privacy for the virtual meeting.

Upon receipt of the recognized speech data 545, the transcription feedback system 600 may determine a confidence rating or score 620 for the recognized speech data 545. In some embodiments, depending on how the speech recognition is performed, the speech recognition system 500 may provide confidence scores for words or phrases as well. That is, the transcription feedback system 600 may determine how confident the system 500 and/or 600 is in the transcription of the recognized speech data 545. For example, for a commonly used word, such as “house,” the transcription feedback system 600 may determine a higher confidence score 620 since the speech recognition system 500, and therefore the transcription feedback system 600, commonly encounter the word. In contrast, for a rarely used word, such as “Leichtenstein,” the transcription feedback system 600 may determine a lower confidence score 620 since the speech recognition system 500, and therefore the transcription feedback system 600, rarely encounters the word.

The confidence score 620 may also be determined using other methods and techniques. For example, the confidence score 620 may be based off of the speech recognition system 500's mapping of the phonemes to words within the vocabulary database 530. The speech recognition system 500 may determine a similarity score for the phonemes within the audio data 510 and words within the vocabulary database 530. If the speech recognition system 500 cannot find a match (e.g., a word having some threshold value of similarity with the phonemes), then the transcription feedback system 600 may determine a lower confidence score 620 for the transcribed word. In some embodiments, the confidence score 620 may be an integer between a minimum and a maximum score (e.g., 1 and 10) with the minimum being a low confidence score and the maximum being a high confidence score. In other embodiments, the confidence score 620 may be a weight or percentage of confidence. Various confidence scoring methods and techniques for transcribed words may be employed by the transcription feedback system 600 to determine the confidence score 620.

The confidence scores 620 for one or more words within the recognized speech data 545 may be received by the feedback module 630. The feedback module 630 may determine one or more transcribed words within the recognized speech data 545 to request feedback on. For example, the feedback module 630 may determine words with a low confidence score 620 as words requiring feedback. The feedback module 630 may select some portion of the low confidence score 620 words or all of the low confidence score 620 words for transcription feedback. In other embodiments, the feedback module 630 may randomly select words within the recognized speech data 545 for feedback.

After the transcribed words are selected by the feedback module 630 for participant feedback, the transcription feedback system 600 may transmit a feedback request 645 to one or more participant client devices. For example, the transcription feedback system 600 may transmit the feedback request 645 to the participant client device 640a. Referring now to FIG. 7, an example transcription feedback request 700 is provided, according to an embodiment herein. The request 700 may be the same or similar to the feedback request 645 and may be presented to a participant or a host during or after a virtual meeting is terminated. The following figures and related components, such as request 700 of FIG. 7, will be described with respect to the system shown in FIGS. 3-6, however, any suitable system according to this disclosure may be employed, such as those described in FIGS. 1 and 2.

The feedback request 700 may include a pane 705 including one or more transcribed words 710 for review. The one or more transcribed words 710 may include the words identified by the feedback module 630 as having a low confidence score. As shown, a transcribed word within the transcribed words 710 may include multi-part words or phrases. These may also be known as “segments” of the transcript. For example, the speech recognition system 500 may identify “owl berta” as a single word based on the participant's speech pattern. The participant may have said “Alberta” but the speech recognition system 500 may not have been able to map the phonemes of “Alberta” with a single word within the vocabulary database 530. As such, the speech recognition system 500 mapped the speech data 510 to the multi-part word or phrase “owl berta.” Recognition by the speech recognition system 500 that the term “owl berta” as a single word without being able to map the phonemes to a single word may impact or cause the lower confidence score 620 of the word. Accordingly, during the transcription feedback process, the transcription feedback system 600 may transmit the segment of the transcript that includes the word “owl berta” to the participant for review.

In some embodiments, the transcription feedback system 600 may also include one or more words before or after the term “owl berta.” For example, if the transcription feedback system 600 cannot identify the term “owl berta” as corresponding to a single word, then the transcription feedback request 700 may include a segment of the transcript surrounding the term “owl berta.” The segment of the transcript may include one or more words surrounding the term “owl berta” since the transcription feedback system 600 is unsure as to the bounds of the inaccurate transcription.

Similarly, during a virtual meeting, the participant may have made reference to the Olympian Grace McCallum who is from Isanti, Minnesota. However, the word “Isanti” is not in the vocabulary database 530. As such, the speech recognition system 500 may have mapped the phonemes for “Isanti” to “I sat here.” Because the term “Isanti” is not in the vocabulary database 530, the confidence score 620 for “I sat here” may be identified by the transcription feedback system 600 as low. Thus, the transcription feedback system 600 may select the phrase “I sat here” for feedback due to its low confidence score 620.

In contrast, the speech recognition system 500 may correctly map the name “McCallum.” The term “McCallum,” however, may not be within the vocabulary database 530. Despite not being within the vocabulary database 530, the speech recognition system 500 may have correctly transcribed the word “McCallum.” The feedback transcription system 600, however, may not know that the word “McCallum” is a correct transcription and, thus, may request feedback on the word.

The transcription feedback request 700 may provide multiple response buttons to the participant. For example, the transcription feedback request 700 may include a “maybe later” button 720 or a similar button that allows the participant to decline to provide feedback. The transcription feedback request 700 may also include a “yes” button 715 that allows a participant to accept the request for feedback. Upon selection of the “yes” button 715 or otherwise acceptance of the feedback request 700, the participant may be provided with a review prompt.

In some embodiments, a participant may provide feedback without receiving a transcription feedback request 700. For example, if the participant is receiving a live transcription, such as the live transcription 410, during a virtual meeting and identifies an incorrect transcription of a word/phrase, the participant may be able to provide feedback at that time. In an example, the participant may select the identified incorrect word/phrase within the live transcription 410 and be able to provide a correction to the word/phrase. In some embodiments, the participant may select the live transcription 410 and be provided with various options, one of which includes providing feedback to the live transcription 410. Upon selection to provide feedback to the live transcription 410 the participant may be provided with a review prompt or the ability to provide feedback, as described herein.

Referring now to FIG. 8, an example review prompt 800 for review of a transcript feedback request is provided, according to an embodiment herein. The review prompt 800 may be presented to a participant or a host during or after a virtual meeting is terminated. For example, the review prompt 800 may be provided to a participant client device after the participant accepts the transcript feedback request, as illustrated in FIG. 7. The following figures and related components, such as the review prompt 800 of FIG. 8, will be described with respect to the system shown in FIG. 7, however, any suitable system according to this disclosure may be employed, such as those described in FIGS. 1-6.

The prompt 800 may provide a participant with quick review of the transcribed word(s) that are under review. To assist the participant in his or her review, the prompt 800 may provide a snippet of audio for each of the transcribed words or phrases being reviewed. For example, to review the transcribed phrase “owl berta” in pane 802, a snippet 808 may be provided, to review the transcribed phrase “I sat here” in pane 804, a snippet 810 may be provided, and to review the transcribed word “McCallum” in pane 806, a snippet 812 may be provided. Each of the snippets 808, 810, and 812 may be a sound clip of the audio stream from which the transcribed word/phrase corresponds. For example, the phrase “I sat here” may, without context, be confusing to a participant trying to determine whether the transcription is correct. Accordingly, the snippet 810 may include a few seconds of the audio before and/or after the transcribed word/phrase is spoken within the audio stream. This may provide context to the transcribed word/phrase. In the present example, the snippet 810 may include a portion of the audio stream that says “the Olympian Grace McCallum is from Isanti, Minnesota.” From the snippet the participant may gain the context that the term “I sat here” is meant to be “Isanti.”

To review the snippets 808, 810, and 812, a participant may select the play button 814 associated with each of the snippets. In some embodiments, the participant may simply select the snippet 808, 810, or 812. Upon review of the snippet 808, and 810, and/or 812, the participant may determine that the corresponding transcribed word is correct or incorrect. If the participant determines that the transcribed word is correct, then the participant can select the “correct transcription” button 816. If, however, the participant determines that the transcribed word is incorrect, then the participant can select the “incorrect transcription” button 818.

In some embodiments, upon selecting the “incorrect transcription” button 818, the participant may be prompted to input a corrected transcription. For example, a prompt 820 may be provided having an input field 822. The participant can provide a correction to the incorrectly transcribed word/phrase in the input field 822. In the present example, the participant may input the word “Alberta” into the input field 822 for the transcribed phrase “owl berta” in the pane 802.

Depending on the privacy settings for a virtual meeting and/or the transcription process, transcribed words under review, and thus the snippets 808, 810, and 812, may only correspond to an audio stream associated with the reviewing participant. For example, if the meeting was not recorded or the transcription process settings have increased privacy selections, then the transcribed words for review may correspond only to the audio stream of the reviewing participant. Because the transcribed words only correspond to spoken words by the participant, the snippets 808, 810, and 812 may only include sound clips from the participant's own audio stream. In contrast, if the meeting is being recorded, and thus the participants were aware their audio streams were being recorded, or if the transcription process privacy settings allow open access to sound clips from all participants' audio streams, then the snippets 808, 810, and 812 may include sound clips from any participant's audio streams.

Returning now to FIG. 6, once the participant provides his or her feedback on the transcribed words within the review prompt 800, the transcription feedback 650 may be transmitted back to the transcription feedback system 600. The transcription feedback system 600 may not accept all transcription feedback 650 as the correct transcription for a transcribed word/phrase. Instead, the transcription feedback system 600 may determine a confidence level for the transcription feedback 650. For example, the transcription feedback system 600 may determine a confidence level of the transcription feedback 650 based on the participant providing the feedback or based on feedback from other participants. The confidence level of the transcription feedback 650 may be based on a comparison of the transcription feedback 650 from multiple participants. For example, the video conference provider 310 may elicit feedback from more than one of the participant client devices 340a-m and compare the feedback from each of the participant client devices 340a-m. The video conference provider 310 may analyze the responses and determine a most accurate correction for the transcribed word. That is, the video conference provider 310 may determine a most common correction within the transcription feedback 650 received from the participant client device 340a-m. If the participant client device 340a consistently provides transcription feedback 650 and/or the participant client device 340a's transcription feedback 650 is typically consistent with other participants' transcription feedback 650, then the video conference provider 310 may associate a high confidence level for the participant client device 340a's transcription feedback 650. In contrast, if the participant client device 340b rarely provides transcription feedback 650 and/or the participant client device 340b's transcription feedback 650 is often inconsistent when compared to other participant's transcription feedback 650, then the video conference provider 310 may assign a low confidence level in the participant client device 340b's transcription feedback 650.

In some embodiments, the feedback module 630 may identify a profile associated with the participant client devices 340a-m providing the transcription feedback 650 to determine a confidence level in the participant's feedback 650. For example, the transcription feedback system 600 via the feedback module 630 may determine a participant associated with the transcription feedback 650. Then, the feedback module 630 may identify a profile associated with the participant in a user profile database 625. The profile for a participant in the user profile database 625 may include a number of transcription feedbacks 650 that the participant has provided and a number of corrections that have been employed by the speech recognition system 500 based on the participant's transcription feedback 650. If the participant rarely provides transcription feedback 650, then the feedback module 630 may determine a low confidence level for the participant's feedback 650. In contrast, if the participant consistently provides transcription feedback 650, then the feedback module 630 may determine a higher confidence level. In still further embodiments, if the participant consistently provides transcription feedback 650 but the corrections provided in the feedback 650 are rarely correct transcriptions of the reviewed words, then the participant's feedback 650 may be determined to have a low confidence level.

When the feedback module 630 determines that a participant's transcription feedback 650 has a high confidence level, the correction to the one or more transcribed words provided to the participant via the review prompt 800 may be incorporated into the speech recognition system 500. For example, the speech recognition module 505 may receive transcription feedback 550 from the transcription feedback system 600. The transcription feedback 550 may be the same or similar to the transcription feedback 650 that has been filtered based on the confidence level assigned to the reviewing participant.

The speech recognition module 505 may incorporate the transcription feedback 550 into the speech recognition process. For example, the vocabulary database 530 may be updated to reflect the correction by adding the term into the keywords database 535. In other embodiments, the speech recognition system 500 may update a mapping of the phonemes for the spoken word to the corrected transcribed word. The speech recognition system 500 and the transcription feedback system 600 may utilize one or more machine learning (ML) techniques for updating the speech recognition process and/or transcription process using the corrections received via the transcription feedback 650.

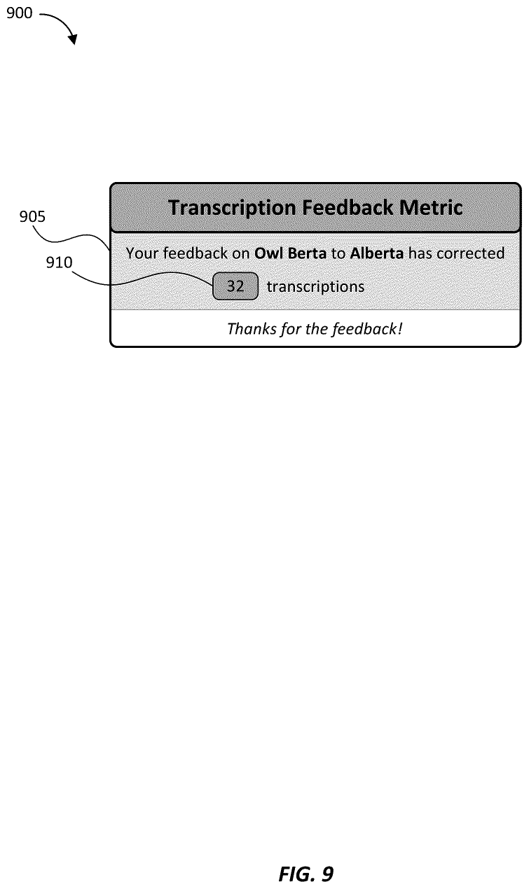

Once a corrected transcription for a word/phrase is updated within the speech recognition system 500, the transcription feedback system 600 may track how many correct transcriptions for that word/phrase have been made. The transcription feedback system 600 may track the number of correct transcriptions a participant has made to encourage the participant to provide transcription feedback 650. For example, referring now to FIG. 9, a metric prompt 900 for transcription feedback is provided, according to an embodiment herein. The metric prompt 900 may be provided to a participant to let the participant know how many corrections have been made based on his or her transcription feedback 650. As illustrated, the metric prompt 900 may include a transcription correction pane 905 that details the transcription that the participant helped correct. Here, the participant's feedback 650 corrected the transcription of “owl berta” to “Alberta.” After receiving the participant's transcription feedback 650, the transcription feedback system 600 tracked the number of times the term “Alberta” was correctly transcribed based on the feedback. The metric prompt 900 then provides the number of times 910 that the correct transcription of “Alberta” has been used. As shown, based on the participant's transcription feedback 650, the term “Alberta” has been correctly transcribed 32 times 910. It should be understood that other metrics may be provided on the metric prompt 900 to encourage a participant's transcription feedback 650 or to track how the participant's transcription feedback 650 has been incorporated into the speech recognition process and/or transcription process.

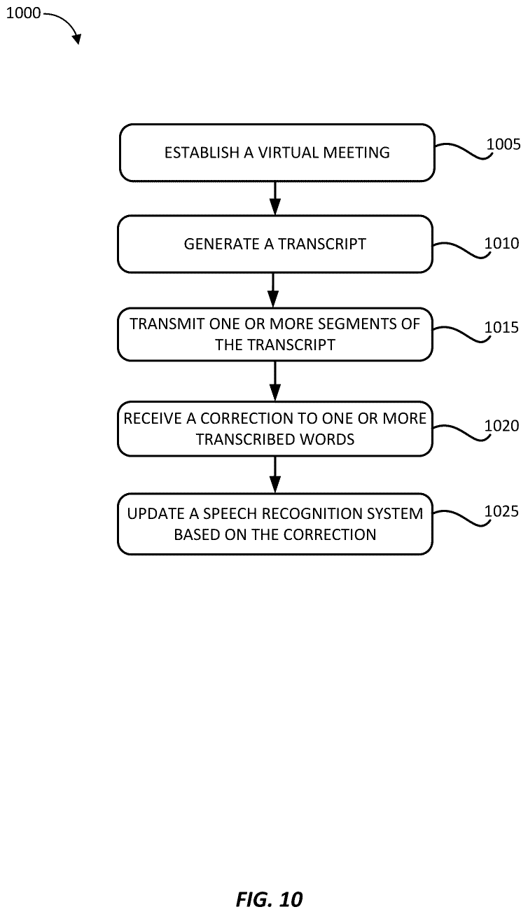

Referring now to FIG. 10, a flowchart of an example method 1000 for providing voice transcription feedback for virtual meeting is provided. The description of the method 1000 in FIG. 10 will be made with reference to FIGS. 3-9, however any suitable system according to this disclosure may be used, such as the example systems 100 and 200, shown in FIGS. 1 and 2.

The method 1000 may include step 1005. At step 1005, a virtual meeting having a plurality of participants may be established by a video conference provider, such as the video conference provider 310. Each participant may exchange one or more audio streams via the virtual meeting. In some embodiments, one or more of the participants may also exchange a video stream during the virtual meeting.

The method 1000 may also include step 1010. At step 1010, the video conference provider may generate a transcript of one or more of the audio streams exchanged during the virtual meeting. For example, the video conference provider may generate the transcript responsive to an indication from one of the participants of the virtual meeting. As discussed above, a participant may request a transcript of the audio streams exchanged during the virtual meeting or after the virtual meeting is terminated. The transcript may be generated using a speech recognition system, such as the speech recognition system 500. For example, step 1010 may further include identifying a plurality of spoken words in the one or more audio streams and transcribing the plurality of spoken words into a plurality of transcribed words. In some embodiments, each of the plurality of transcribed words may be scored based on a confidence level of the transcription. In another embodiments, the method may further include determining an audio stream corresponding to the first client device and identifying the spoken words within the audio stream corresponding to the first client device.

At step 1015, one or more segments of the transcript may be transmitted to a first client device. For example, following the above example embodiment, the method may include determining one or more transcribed words/phrases within the transcribed words/phrases that have a low confidence level. Then, based on the low confidence level, the method may include transmitting, to the first client device, the one or more transcribed words/phrases having the low confidence level. Feedback may be requested based on the one or more transcribed words/phrases having the low confidence level.

The method 1000 may also include step 1020. At step 1020, a correction to one or more transcribed words within the one or more segments of the transcript may be received from the first client device. For example, step 1020 may include receiving an indication that one or more transcribed words are not a correct transcript of corresponding spoken words within the audio streams from the virtual meeting and receiving one or more corrected words corresponding to the one or more transcribed words.

In some embodiments, the method may further include determining a profile associated with the first client device and determining a confidence score for the correction received from the first client device based on the profile associated with the first client device. For example, the confidence score for the correction received from the first client device may be based on a number of corrections received from the first client device, as indicated by the profile.

The method 1000 may also include step 1025. At step 1025, the method may include updating, by the video conference provider, the speech recognition system based on the correction to the one or more transcribed words within the transcription. For example, an incorrect transcription of a word may be corrected to generate a correct transcription of that word. In some embodiments, the transcript generated by the video conference provider of the audio streams exchanged during the virtual meeting may also be updated based on the correction.

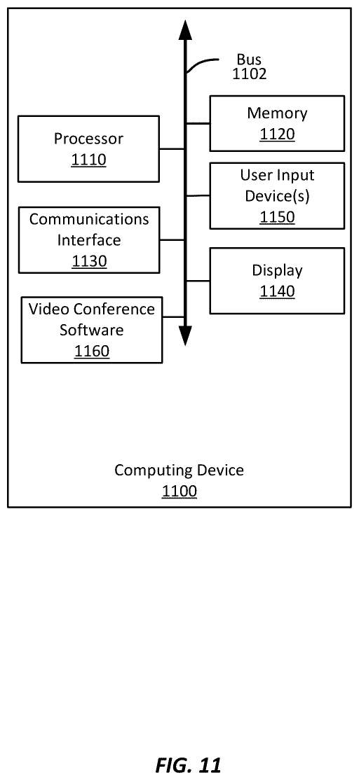

Referring now to FIG. 11, FIG. 11 shows an example computing device 1100 suitable for use in example systems or methods providing voice transcription feedback for virtual meeting. The example computing device 1100 includes a processor 1110 which is in communication with the memory 1120 and other components of the computing device 1100 using one or more communications buses 1102. The processor 1110 is configured to execute processor-executable instructions stored in the memory 1120 to perform one or more methods for providing voice transcription feedback for virtual meeting, such as part or all of the example method 1000, described above with respect to FIG. 10. The computing device, in this example, also includes one or more user input devices 1150, such as a keyboard, mouse, touchscreen, video input device (e.g., one or more cameras), microphone, etc., to accept user input. The computing device 1100 also includes a display 1140 to provide visual output to a user.

The computing device 1100 also includes a communications interface 1130. In some examples, the communications interface 1130 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification

As used below, any reference to a series of examples is to be understood as a reference to each of those examples disjunctively (e.g., “Examples 1-4” is to be understood as “Examples 1, 2, 3, or 4”).

Example 1 is a system comprising: a non-transitory computer-readable medium; a communications interface; and a processor communicatively coupled to the non-transitory computer-readable medium and the communications interface, the processor configured to execute processor-executable instructions stored in the non-transitory computer-readable medium to: establish a virtual meeting having a plurality of participants, each participant of the plurality of participants exchanging one or more audio streams via the virtual meeting; generate a transcript of at least a subset of the one or more audio streams exchanged during the virtual meeting using a speech recognition system; transmit, to a first client device, one or more segments of the transcript; receive, from the first client device, a correction to one or more transcribed words within the one or more segments of the transcript; and update the speech recognition system based on the correction to the one or more transcribed words within the transcript.

Example 2 is the system of any previous or subsequent Example, wherein the instructions to generate the transcript further cause the processor to execute further processor-executable instructions stored in the non-transitory computer-readable medium to: transcribe a plurality of spoken words into a plurality of transcribed words; generate a confidence score for each of the plurality of transcribed words; and determine one or more transcribed words within the plurality of transcribed words having a low confidence score.

Example 3 is the system of any previous or subsequent Example, wherein the processor is configured to execute further processor-executable instructions stored in the non-transitory computer-readable medium to: provide, to the first client device, an indication of the one or more transcribed words having the low confidence score; and request, from the first client device, feedback on the one or more transcribed words having the low confidence score.

Example 4 is the system of any previous or subsequent Example, wherein the processor is configured to execute further processor-executable instructions stored in the non-transitory computer-readable medium to: determine the one or more segments of the transcript containing transcribed words corresponding to an audio stream associated with the first client device; and transmit, to the first client device, one or more snippets of an audio stream corresponding to each of the one or more segments of the transcript.

Example 5 is the system of any previous or subsequent Example, wherein the processor is configured to execute further processor-executable instructions stored in the non-transitory computer-readable medium to: transmit, to the first client device, a snippet of an audio stream corresponding to each of the one or more segments of the transcript.

Example 6 is the system of any previous or subsequent Example, wherein the processor is configured to execute further processor-executable instructions stored in the non-transitory computer-readable medium to: update the transcript of at least the subset of the one or more audio streams using the correction to the one or more transcribed words.

Example 7 is a method comprising: establishing, by a video conference provider, a virtual meeting having a plurality of participants, each participant of the plurality of participants exchanging one or more audio streams via the virtual meeting; generating, by the video conference provider a transcript of at least a subset of the one or more audio streams exchanged during the virtual meeting using a speech recognition system; transmitting, to a first client device, one or more segments of the transcript; receiving, from the first client device, a correction to one or more transcribed words within the one or more segments of the transcript; and updating, by the video conference provider, the speech recognition system based on the correction to the one or more transcribed words within the transcript.

Example 8 is the method of any previous or subsequent Example, wherein receiving, from the first client device, the correction to the one or more transcribed words comprises: receiving an indication that the one or more transcribed words are not a correct transcript of corresponding spoken words within at least the subset of the one or more audio streams; and receiving one or more corrected words corresponding to the one or more transcribed words.

Example 9 is the method of any previous or subsequent Example, the method further comprising: determining a profile associated with the first client device; and determining a confidence score for the correction received from the first client device based on the profile associated with the first client device.

Example 10 is the method of any previous or subsequent Example, wherein determining the confidence score for the correction received from the first client device based on the profile associated with the first client device further comprises:: determining, based on the profile, a number of corrections received from the first client device; and determining, based on the number of corrections received from the first client device, the confidence score for the correction received from the first client device.

Example 11 is the method of any previous or subsequent Example, wherein the generating the transcript of at least the subset of the one or more audio streams further comprises: identifying a plurality of spoken words in at least the subset of the one or more audio streams; transcribing the plurality of spoken words into a plurality of transcribed words; and scoring each of the plurality of transcribed words using a confidence level.

Example 12 is the method of any previous or subsequent Example, wherein the method further comprises: determining one or more transcribed words within the plurality of transcribed words having a low confidence level; transmitting, to the first client device, the one or more transcribed words having the low confidence level; and requesting feedback on the one or more transcribed words having the low confidence level.

Example 13 is the method of any previous or subsequent Example, wherein receiving, from the first client device, the correction to one or more transcribed words within the one or more segments of the transcript occurs during the virtual meeting, and the method further comprises: transcribing at least the subset of the one or more audio streams for a remainder of the virtual meeting using the correction to the one or more transcribed words.

Example 14 is the method of any previous or subsequent Example, wherein the one or more segments of the transcript transmitted to the first client device correspond to an audio stream corresponding to the first client device.

Example 15 is a non-transitory computer-readable medium comprising processor-executable instructions configured to cause one or more processors to: establish a virtual meeting having a plurality of participants, each participant of the plurality of participants exchanging one or more audio streams via the virtual meeting; generate a transcript of at least a subset of the one or more audio streams exchanged during the virtual meeting using a speech recognition system; transmit, to a first client device, one or more segments of the transcript; receive, from the first client device, a correction to one or more transcribed words within the one or more segments of the transcript; and update the speech recognition system based on the correction to the one or more transcribed words within the transcript.

Example 16 is the non-transitory computer-readable medium of any previous or subsequent Example, wherein the processor-executable instructions to generate the transcript of at least the subset of the one or more audio streams cause the processor to execute further processor-executable instructions stored in the non-transitory computer-readable medium to: generate the transcript of at least the subset of the one or more audio streams during the virtual meeting as the audio streams are being exchanged between the plurality of participants.

Example 17 is the non-transitory computer-readable medium of any previous or subsequent Example, wherein the processor-executable instructions to generate the transcript of at least the subset of the one or more audio streams cause the processor to execute further processor-executable instructions stored in the non-transitory computer-readable medium to: generate the transcript after the virtual meeting is terminated.

Example 18 is the non-transitory computer-readable medium of any previous or subsequent Example, wherein the processor is configured to execute further processor-executable instructions stored in the non-transitory computer-readable medium to: receive, from a second client device, an indication to transcribe a second set of audio streams corresponding to a second virtual meeting; and transcribe the second set of audio streams using the correction to the one or more transcribed words.

Example 19 is the non-transitory computer-readable medium of any previous or subsequent Example, wherein the one or more segments of the transcript correspond to an audio stream associated with the first client device.

Example 20 is the non-transitory computer-readable medium of any previous or subsequent Example, wherein the processor is configured to execute further processor-executable instructions stored in the non-transitory computer-readable medium to: provide, to the first client device, a correction metric based in part on the correction to the one or more transcribed words.

That which is claimed is:

1. A system comprising:
a non-transitory computer-readable medium;
a communications interface; and
a processor communicatively coupled to the non-transitory computer-readable medium and the communications interface, the processor configured to execute processor-executable instructions stored in the non-transitory computer-readable medium to:
establish a virtual meeting having a plurality of participants, each participant of the plurality of participants exchanging one or more audio streams via the virtual meeting;
generate a transcript of at least a subset of the one or more audio streams exchanged during the virtual meeting using a speech recognition system;
transmit, to a first client device, one or more segments of the transcript;
receive, from the first client device, a correction to one or more transcribed words within the one or more segments of the transcript; and
update the speech recognition system based on the correction to the one or more transcribed words within the transcript.

2. The system of claim 1, wherein the instructions to generate the transcript further cause the processor to execute further processor-executable instructions stored in the non-transitory computer-readable medium to:
transcribe a plurality of spoken words into a plurality of transcribed words;
generate a confidence score for each of the plurality of transcribed words; and
determine one or more transcribed words within the plurality of transcribed words having a low confidence score.

3. The system of claim 2, wherein the processor is configured to execute further processor-executable instructions stored in the non-transitory computer-readable medium to:
provide, to the first client device, an indication of the one or more transcribed words having the low confidence score; and
request, from the first client device, feedback on the one or more transcribed words having the low confidence score.

4. The system of claim 1, wherein the processor is configured to execute further processor-executable instructions stored in the non-transitory computer-readable medium to:
determine the one or more segments of the transcript containing transcribed words corresponding to an audio stream associated with the first client device; and
transmit, to the first client device, one or more snippets of an audio stream corresponding to each of the one or more segments of the transcript.

5. The system of claim 1, wherein the processor is configured to execute further processor-executable instructions stored in the non-transitory computer-readable medium to:
transmit, to the first client device, a snippet of an audio stream corresponding to each of the one or more segments of the transcript.

6. The system of claim 1, wherein the processor is configured to execute further processor-executable instructions stored in the non-transitory computer-readable medium to:
update the transcript of at least the subset of the one or more audio streams using the correction to the one or more transcribed words.

7. A method comprising:
establishing, by a video conference provider, a virtual meeting having a plurality of participants, each participant of the plurality of participants exchanging one or more audio streams via the virtual meeting;
generating, by the video conference provider a transcript of at least a subset of the one or more audio streams exchanged during the virtual meeting using a speech recognition system;
transmitting, to a first client device, one or more segments of the transcript;
receiving, from the first client device, a correction to one or more transcribed words within the one or more segments of the transcript; and
updating, by the video conference provider, the speech recognition system based on the correction to the one or more transcribed words within the transcript.

8. The method of claim 7, wherein receiving, from the first client device, the correction to the one or more transcribed words comprises:
receiving an indication that the one or more transcribed words are not a correct transcript of corresponding spoken words within at least the subset of the one or more audio streams; and
receiving one or more corrected words corresponding to the one or more transcribed words.

9. The method of claim 7, the method further comprising:
determining a profile associated with the first client device; and
determining a confidence score for the correction received from the first client device based on the profile associated with the first client device.

10. The method of claim 9, wherein determining the confidence score for the correction received from the first client device based on the profile associated with the first client device further comprises::
determining, based on the profile, a number of corrections received from the first client device; and
determining, based on the number of corrections received from the first client device, the confidence score for the correction received from the first client device.

11. The method of claim 7, wherein the generating the transcript of at least the subset of the one or more audio streams further comprises:
identifying a plurality of spoken words in at least the subset of the one or more audio streams;
transcribing the plurality of spoken words into a plurality of transcribed words; and
scoring each of the plurality of transcribed words using a confidence level.

12. The method of claim 11, wherein the method further comprises:
determining one or more transcribed words within the plurality of transcribed words having a low confidence level;
transmitting, to the first client device, the one or more transcribed words having the low confidence level; and
requesting feedback on the one or more transcribed words having the low confidence level.

13. The method of claim 8, wherein receiving, from the first client device, the correction to one or more transcribed words within the one or more segments of the transcript occurs during the virtual meeting, and the method further comprises:
transcribing at least the subset of the one or more audio streams for a remainder of the virtual meeting using the correction to the one or more transcribed words.

14. The method of claim 8, wherein the one or more segments of the transcript transmitted to the first client device correspond to an audio stream corresponding to the first client device.

15. A non-transitory computer-readable medium comprising processor-executable instructions configured to cause one or more processors to:
establish a virtual meeting having a plurality of participants, each participant of the plurality of participants exchanging one or more audio streams via the virtual meeting;
generate a transcript of at least a subset of the one or more audio streams exchanged during the virtual meeting using a speech recognition system;
transmit, to a first client device, one or more segments of the transcript;
receive, from the first client device, a correction to one or more transcribed words within the one or more segments of the transcript; and
update the speech recognition system based on the correction to the one or more transcribed words within the transcript.

16. The non-transitory computer-readable medium of claim 15, wherein the processor-executable instructions to generate the transcript of at least the subset of the one or more audio streams cause the processor to execute further processor-executable instructions stored in the non-transitory computer-readable medium to:
generate the transcript of at least the subset of the one or more audio streams during the virtual meeting as the audio streams are being exchanged between the plurality of participants.

17. The non-transitory computer-readable medium of claim 15, wherein the processor-executable instructions to generate the transcript of at least the subset of the one or more audio streams cause the processor to execute further processor-executable instructions stored in the non-transitory computer-readable medium to:
generate the transcript after the virtual meeting is terminated.

18. The non-transitory computer-readable medium of claim 15, wherein the processor is configured to execute further processor-executable instructions stored in the non-transitory computer-readable medium to:
receive, from a second client device, an indication to transcribe a second set of audio streams corresponding to a second virtual meeting; and
transcribe the second set of audio streams using the correction to the one or more transcribed words.

19. The non-transitory computer-readable medium of claim 15, wherein the one or more segments of the transcript correspond to an audio stream associated with the first client device.

20. The non-transitory computer-readable medium of claim 15, wherein the processor is configured to execute further processor-executable instructions stored in the non-transitory computer-readable medium to:
provide, to the first client device, a correction metric based in part on the correction to the one or more transcribed words.
